(19) United States
(12) Patent Application Publication
(10) Pub. No.: US 2004/0068079 A1
(43) Pub. Date: Apr. 8, 2004

(54) Two-component systems for producing elastic coatings

(76) Inventors: Meike Niesten, Koln (DE); Lutz Schmalstieg, Koln (DE); Joachim Simon, Dusseldorf (DE)

Correspondence Address: BAYER POLYMERS LLC, 100 BAYER ROAD, PITTSBURGH, PA, 15205, US

(21) Appl. No.: 10/678,510

(22) Filed: Oct. 3, 2003

(30) Foreign Application Priority Data
Oct. 7, 2002 (DE) 10246707.2

(51) Int. Cl. C08G 18/10; C08G 18/30; C08G 18/32

(52) U.S. Cl. 528/59; 528/60; 528/61

(57) ABSTRACT

The present invention relates to two-component coating systems with extended pot life for producing elastic coatings. The coating systems comprise polyurethane prepolymers based on polyether polyols prepared in the presence of double metal cyanide (DMC) catalysts and also comprise sterically hindered aromatic diamine curing agents.

### CROSS REFERENCE TO RELATED PATENT APPLICATION

The present patent application claims the right of priority under 35 U.S.C. §119, (a)-(d) of German Patent Application No. ______, filed ______ ______, 2002.

### FIELD OF THE INVENTION

The present invention relates to two-component coating systems with extended pot life for producing elastic coatings. The coating systems comprise polyurethane prepolymers based on polyether polyols prepared in the presence of double metal cyanide (DMC) catalysts and also comprise sterically hindered aromatic diamine curing agents.

### BACKGROUND OF THE INVENTION

Two-component coating systems based on polyurethane or polyurea are known and are employed in the art. In general they comprise a liquid polyisocyanate component and a liquid isocyanate-reactive component. Reaction of polyisocyanates with amines as an isocyanate-reactive component produces highly crosslinked, solvent-free polyurea coatings. Primary amines and isocyanates, however, generally react with one another very rapidly. Typical pot lives or gel times often amount to just several seconds to a few minutes. Consequently such polyurea coatings cannot be applied manually but instead only with special spraying apparatus. Such coatings nevertheless possess excellent physical properties. The reaction between polyisocyanates and amines can be retarded by using secondary amines, but the pot lives are still too short for manual application.

A method of reducing the reactivity that is known from the literature is to use prepolymers with a low NCO content. Systems based on polyoxypropylenepolyols, however, lack sufficient mechanical stability. Prepolymers based on polyoxytetramethylene glycol, which are disclosed by U.S. Pat. No. 4,581,433, crystallize at room temperature and are therefore unsuitable for coating compositions.

U.S. Pat. Nos. 3,428,610 and 4,463,126 disclose the preparation of polyurethane/polyurea elastomers by curing of NCO-functional prepolymers with aromatic diamines. These are preferably diprimary aromatic diamines which have at least one alkyl substituent with 2-3 carbon atoms that is positioned ortho to each amino group and may also have methyl substituents in further positions ortho to the amino groups, such as diethyltoluenediamine (DETDA), for example. At high NCO contents, however, the pot life of such systems is relatively short, while at low NCO contents the mechanical stability is inadequate.

U.S. Pat. No. 4,463,126 describes a process for preparing solvent-free elastic coatings in the course of which NCO prepolymers based on isophorone diisocyanate (IPDI) and polyetherpolyols are cured at room temperature using sterically hindered diprimary aromatic diamines. When prepolymers with a very low NCO content are used, however, the mechanical properties of such coatings are unsatisfactory.

There is an established need in the art for coating compositions, which have sufficiently long pot lives to allow for manual application, and, which provide elastic-coatings having improved mechanical properties.

### SUMMARY OF THE INVENTION

The present invention is directed to a two-component coating system that includes:

(i) a prepolymer containing free isocyanate groups, having an NCO content of from 0.4 to 12% by weight, obtainable by reacting a di- or polyisocyanate with one or more polyoxyalkylene polyols having an average hydroxy functionality of from 1.96 to 6 and an equivalent weight of at least 250 g/mol, wherein the polyoxyalkylene polyols are obtained by alkoxylating hydroxy-functional starter molecules in the presence of double metal cyanide catalysts, and

(ii) a diprimary aromatic diamine having at least one alkyl substituent having 2-3 carbon atoms positioned ortho to each amino group.

The present invention is further directed to a coating composition obtained by reacting components (i) and (ii) of the inventive two-component coating system, polyureas prepared thereby, and a process for producing elastic coatings including mixing the components of the two-component coating system, applying the mixture to a substrate, and curing the two-component coating system mixture.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

Coating compositions have now been found which have sufficiently long pot lives to allow even manual application, and with which elastic coatings having improved mechanical properties can be produced.

The present invention provides a two-component coating systems comprising

(i) a prepolymer containing free isocyanate groups, having an NCO content of from 0.4 to 12% by weight, in some cases from 1 to 7% by weight, and in other cases from 1.5 to 4% by weight, obtainable by reacting a di- or polyisocyanate with one or more polyoxyalkylene polyols obtainable by alkoxylating hydroxy-functional starter molecules in the presence of double metal cyanide (DMC) catalysts and having an average hydroxy functionality of from 1.96 to 6, in some cases from 1.96 to 3, and an equivalent weight of at least 250 g/mol, and

(ii) a diprimary aromatic diamine having at least one alkyl substituent having 2-3 carbon atoms that is positioned ortho to each amino group and optionally also having methyl substituents in further positions ortho to the amino groups.

As used herein, the term “diprimary aromatic diamine” refers to an aromatic compound that contains two primary amine substituent groups.

As used herein, the term “ortho to the amino groups” is meant to infer that a group is located at a carbon immediately adjacent to the carbon atom with an amino group substituent in an aromatic ring. In a benzene ring, the ortho positions are at 2 and 5, with respect to the amino group containing carbon at position 1.

The isocyanate component (i) is a prepolymer containing isocyanate groups and having an NCO content of from 0.4 to 12% by weight, in some cases from 1 to 7% by weight, and in other cases from 1.5 to 4% by weight, which is obtainable by reacting at least one polyisocyanate with one or more polyoxyalkylene polyols which are obtainable by alkoxylating hydroxy-functional starter compounds with one or more alkylene oxides, non-limiting examples being propylene oxide and mixtures of propylene oxide and ethylene oxide, in the presence of DMC catalysts and which have an average hydroxy functionality of from 1.96 to 6, in some cases from 1.96 to 3, and an equivalent weight of at least 250 g/mol or a number average molecular weight of from 500 to 20 000, in some cases from 1000 to 8000, and in other cases from 2000 to 6000 g/mol.

Suitable DMC catalysts for the polyaddition reaction of alkylene oxides with starter compounds containing active hydrogen atoms are known. With preference the polyoxyalkylene polyols for preparing the prepolymers (i) of the invention DMC catalysts based on zinc hexacyanocobaltate are used especially those additionally containing tert-butanol as an organic complex ligand (alone or in combination with a polyether), as disclosed by EP-A 700 949, EP-A 761 708 and WO 97/40086. With these catalysts it is possible to obtain polyoxyalkylene polyols which in comparison to polyols prepared with alkali metal hydroxide catalysts contain a reduced fraction of monofunctional polyethers having terminal double bonds, known as monools. The polyoxyalkylene polyols for use in accordance with the invention typically have double bond contents of less than 50 mmol/kg, in some cases less than 20 mmol/kg and in other cases less than 10 mmol/kg.

Suitable polyisocyanates include, but are not limited to, aromatic, aliphatic and cycloaliphatic polyisocyanates. Suitable polyisocyanates further include, but are not limited to, compounds of the formula Q(NCO)ₙ having a number-average molecular weight of less than 800 g/mol, in which n is a number from 2 to 4 and Q is an aromatic C₆-C₁₅ hydrocarbon radical, an aliphatic C₄-C₁₂ hydrocarbon radical or a cycloaliphatic C₆-C₁₅ hydrocarbon radical. Non-limiting examples are diisocyanates such as toluene diisocyanate (TDI), methylenediphenyl diisocyanate (MDI), triisocyanatononane (TIN), naphthyl diisocyanate (NDI), 4,4′-diisocyanatodicyclohexylmethane, 3-isocyanatomethyl-3,3,5-trimethylcyclohexyl isocyanate (isophorone diisocyanate=IPDI), tetramethylene diisocyanate, hexamethylene diisocyanate (HDI), 2-methylpentamethylene diisocyanate, 2,2 4-trimethylhexamethylene diisocyanate (THDI), dodecanmethylene diisocyanate 1,4-diisocyanatocyclohexane, 4,4′-diisbcyanato-3,3′-dimethyldicyclo-hexylmethahe, 4,4′-diisocyanato-2,2-dicyclohexylpropane, 3-isocyanatomethyl-1-methyl-1-isocyanatocyclohexane (MCI), 1,3-diisooctylcyanato-4-methylcyclohexane, 1,3-diisocyanato-2-methylcyclohexane and α,α,α′,α′-tetramethyl-m-xylylene diisocyanate or α,α,α′α′-tetramethyl-p-xylylene duisocyanate (TMXDI) and also mixtures consisting of these compounds.

Preference is given to cycloaliphatic or aromatic diisocyanates particular preference to isocyanatomethyl-3,3,5-trimethylcyclohexyl isocyanate (IPDI), toluene 2,4-diisocyanate and toluene 2,6-diisocyanate (TDI):and methylene-diphenyl diisocyanate (MDI), and also to mixtures of these compounds.

To prepare the NCO prepolymers the polyisocyanate and the polyoxyalkylene polyol or mixtures thereof are reacted to form urethane while observing an NCO/OH equivalents ratio of from 1.5:1 to 10:1. The reaction takes place at temperatures from 40 to 140° C., in some cases from 50 to 110° C. If a polyisocyanate excess of more than 2:1 is used excess monomeric polyisocyanate is removed after the reaction by means of distillative or extractive techniques which are customary in the art (e.g. thin-film distillation).

The reaction can be accelerated by using a catalyst which accelerates the formation of urethane. Common catalysts include, but are not limited to, organometallic compounds, amines (e.g. tertiary amines) or metal compounds such as lead octoate, mercury succinate, tin octoate or dibutyltin dilaurate. In many cases from 0.001 to 5% by weight, in other cases from 0.002 to 2% by weight, of catalyst or catalyst combination, based on the overall weight of the prepolymer batch can be used.

The curing component (ii) comprises diprimary aromatic diamines having at least one alkyl substituent having 2 to 3 carbon atoms that is positioned ortho to each amino group and optionally also having methyl substituents in further positions ortho to the amino groups. These compounds can have a molecular weight of from 178 to 346. Typical non-limiting examples of aromatic diamines of this kind are 1-methyl-3,5-diethyl-2,4-diaminobenzene, 1-methyl-3,5-diethy-2,6-diaminobenzene, 1,3,5-triethyl-2,6-diaminobenzene, 3,5,3′,5′-tetraethyl-4,4′-diaminodiphenylmethane, 3,5,3′,5′-tetraisopropyl-4,4′-diaminodiphenylmethane, 3,5-diethyl-3′,3′-diisopropyl-4,4′-diaminodiphenylmethane or any mixtures of such diamines.

The invention also provides coating compositions obtainable by reacting components (i) and (ii), these components being used in amounts such that the equivalents ratio of the isocyanate groups of component (i) to the amino groups of component (ii) is from 0.5:1 to 1.5:1, in some cases from 0.9:1 to 1.5:1.

In order to prepare the coating compositions of the invention the individual components and any auxiliaries and additives that are to be used as well are mixed with one another. The reaction mixtures react to give polyureas even at room temperature and consequently have only a limited pot life. The reaction mixtures must be processed within this pot life. The coating compositions of the invention have a pot life at 23° C. of from 30 to 100 minutes, in some cases from 45 to 90 minutes, the pot life being defined as the period of time within which the coating can be applied homogeneously without forming strings.

Non-limiting examples of auxiliaries and additives that may be intended for use during the preparation of the coating compositions of the invention are pigments, fillers, plasticizers such as coal tar, or levelling assistants.

The two-component binders of the invention are particularly suitable for producing elastic coatings. The coating compositions obtainable from the binders of the invention can be applied to any desired substrates by methods which are known per se, for example by spraying, brushing, flow coating or with the aid of rollers or doctor blades. Examples of suitable substrates include metal, wood, glass, stone, ceramic materials, concrete, hard and flexible plastics, textiles leather or paper.

From the coating compositions of the invention it is possible to obtain coatings having outstanding mechanical properties, with a hardness of at least 40 Shore A and an elongation at break of at least 300%.

### EXAMPLES

Examples 1-3 describe the preparation of typical prepolymers.

### Example 1

174 g (2 eq) of toluene 2,4-diisocyanate (Desmodur® T100, Bayer AG) were introduced under nitrogen at 50° C. A mixture of 1800 g (0.9 eq) of a polyoxypropylene glycol having a number-average molecular weight of 4000 g/mol (Acclaim® 4200, Bayer AG) and 100 g (0. 1) of a polyoxypropylene glycol having a number-average molecular weight of 2000 g/mol (Acclaim® 2200, Bayer AG) was slowly added dropwise at a rate such that the temperature did not exceed 70° C. After 28 hours of stirring at a reaction temperature of between 60 and 70° C. the theoretically calculated NCO content of 2.03% by weight had been reached. The reaction was ended and the product cooled to room temperature.

The NCO prepolymer obtained had an NCO content of 2.00% by weight and a viscosity of 6500 mPa.s at 23° C.

### Example 2

250 g (2 eq) of a mixture of 65% 2,4′-diphenylmethane diisocyanate and 35% 4,4′-diphenylmethane diisocyanate (Desmodur® PU 1806) were introduced under nitrogen at 60° C. A mixture of 1200 g (0.6 eq) of a polyoxypropylene glycol having a number-average molecular weight of 4000 g/mol (Acclaim® 4200, Bayer AG) and 400 g (0.4 eq) of a polyoxypropylene glycol having a number-average molecular weight of 2000 g/mol (Acclaim® 2200, Bayer AG) was slowly added dropwise at a rate such that the temperature did not exceed 70° C. After 12 hours of stirring at a reaction temperature of between 60 and 70° C. the theoretically calculated NCO content of 2.27% by weight had been reached. The reaction was ended and the product cooled to room temperature.

The NCO prepolymer obtained had an NCO content of 2.20% by weight and a viscosity of 25 000 mPa.s at 23° C.

### Example 3

222 g (2 eq) of 1-isocyanato-3-isocyanatomethyl-3,5,5-trimethylcyclohexane (Desmodur® I, Bayer AG) were introduced under nitrogen at 60° C. A mixture of 1400 g (0.7 eq) of a polyoxypropylene glycol having a number-average molecular weight of 4000 g/mol (Acclaim® 4200, Bayer AG) and 600 g (0.3 eq) of a polyoxypropylene glycol prepared starting from glycol and having a number-average molecular weight of 6000 g/mol (Acclaim® 6300, Bayer AG) was slowly added dropwise at a rate such that the temperature did not exceed 70° C. Following the dropwise addition 0.0022 g (25 ppm) of dibutyltin laureate (DBTL) was added. During the reaction the temperature did not exceed 70° C. After 6 hours of stirring at a reaction temperature of between 60 and 70° C. the theoretically calculated NCO content of 2.89% by weight had been reached. The reaction was ended and the product cooled to room temperature.

The NCO prepolymer obtained had an NCO content of 1.80% by weight and a viscosity of 17 000 mPa.s at 23° C.

The following example describes the production of coatings and their mechanical properties.

### Example 4

Prepolymers prepared in analogy to Examples 1-3 were cured at room temperature with a mixture of 80% 3,5-diethyltoluene-2,4-diamine and 20% 3,5-diethyltoluene-2,6-diamine (curing agent DT Bayer AG Leverkusen), observing an NCO/NH₂ ratio of 1.05:1 and 1.2:1 respectively. Table 1 compiles the pot lives and the mechanical properties of the coatings obtained. The Shore A hardness was determined in accordance with DIN 53505, tensile strength and elongation at break in accordance with DIN/ISO 527, tear propagation resistance in accordance with DIN 53515.Table 1

| | | | | | Tensile | Elongation | Tear propagation | |
|---|---|---|---|---|---|---|---|---|
| | Polyether* | NCO content | NCO/NH₂ | Pot life | strength | at break | resistance | Hardness |
| Isocyanate | (Acclaim) | [% by weight] | ratio | [min] | [N/mm^{2]} | [%] | [N/mm] | [Shore A] |
| TDI | 2200/4200 = 1 /9 | 2.0 | 1.05 | 45 | 11.3 | >1500 | 24.7 | 52 |
| TDI | 2200/4200 = 1/9 | 2.0 | 1.2 | 45 | 9.5 | 890 | 18.9 | 55 |
| IPDI | 2200/4200 = 1/2 | 2.2 | 1.05 | 60 | — | — | — | 55 |
| IPDI | 2200/4200 = 1/2 | 2.2 | 1.2 | 60 | — | — | — | 59 |
| IPDI | 2200/4200 = 1/9 | 1.7 | 1.05 | 70 | 18.1 | 1040 | 18.6 | 52 |
| IPDI | 2200/4200 = 1/9 | 1.7 | 1.2 | 70 | 18 | >900 | 16.3 | 49 |
| IPDI | 4200/6300 = 9/1 | 1.9 | 1.05 | 60 | >10 | >1340 | 20.8 | 48 |
| IPDI | 4200/6300 = 9/1 | 1.9 | 1.2 | 60 | 8 | 863 | 15.3 | 51 |
| IPDI | 4200/6300 = 7/3 | 1.8 | 1.05 | 60 | 7.5 | 826 | 12.7 | 49 |
| IPDI | 4200/6300 = 7/3 | 1.8 | 1.2 | 60 | 4.8 | 498 | 8.2 | 52 |
| IPDI | 4200/6300 = 6/4 | 1.9 | 1.05 | 60 | 3.7 | 407 | 9.8 | 54 |
| IPDI | 4200/6300 = 6/4 | 1.9 | 1.2 | 60 | 3.4 | 365 | 10.2 | 48 |
| IPDI | 4200/6300 = 5/5 | 1.8 | 1.05 | 60 | 3.9 | 450 | 10.1 | 51 |
| IPDI | 4200/6300 = 5/5 | 1.8 | 1.2 | 60 | 3.5 | 335 | 8.6 | 54 |

*Ratio of the polyethers in the mixture based on equivalent weight

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A two-component coating system comprising:
(i) a prepolymer containing free isocyanate groups, having an NCO content of from 0.4 to 12% by weight, obtainable by reacting a di- or polyisocyanate with one or more polyoxyalkylene polyols having an average hydroxy functionality of from 1.96 to 6 and an equivalent weight of at least 250 g/mol, wherein the polyoxyalkylene polyols are obtained by alkoxylating hydroxy-functional starter molecules in the presence of double metal cyanide catalysts, and
(ii) a diprimary aromatic diamine having at least one alkyl substituent having 2-3 carbon atoms positioned ortho to each amino group.

2. The coating system of claim 1, wherein the polyisocyanate of (i) is one or more selected from the group consisting of toluene diisocyanate (TDI), methylenediphenyl diisocyanate (MDI), triisocyanatononane (TIN), naphthyl diisocyanate (NDI), 4,4′-diisocyanatodicyclohexylmethane, 3-isocyanatomethyl 3,3,5-trimethylcyclohexyl isocyanate (isophorone diisocyanate=IPDI), tetramethylene diisocyanate, hexamethylene diisocyanate (HDI), 2-methylpentamethylene diisocyanate, 2,2,4-trimethylhexamethylene disocyanate (THDI), dodecamethylene diisocyanate, 1,4-diisocyanatocyclohexane, 4,4′-diisocyanate-3,3′-dimethyldicyclohexylmethane 4,4′-diisocyanato-2,2-dicyclohexylpropane, 3-isocyanatomethyl-1-methyl-1-isocyanatocyclohexane (MCI), 1,3-diisooctylcyanato-4-methylcyclohexane, 1,3-diisocyanato-2-methylcyclohexane and α,α,α′,α′-tetramethyl-m-xylylene diisocyanate or α,α,α′α′-tetramethyl-p-xylylene diisocyanate (TMXDI) and mixtures thereof.

3. The coating system of claim 1, wherein the polyoxyalkylene polyols in (i) have a double bond content of less than 50 mmol/kg.

4. The coating system of claim 1, wherein the diprimary aromatic diamine (ii) includes one or more diamines selected from the group consisting of 1-methyl-3,5-diethyl-2,4-diaminobenzene, 1-methyl-3,5-diethyl-2,6-diaminobenzene, 1,3,5-triethyl-2,6-diaminobenzene, 3,5,3′,5′-tetraethyl-4,4′-diaminodiphenylmethane, 3,5,3′,5′-tetraisopropyl-4,4′-diaminodiphenylmethane, 3,5-diethyl-3′,3′-diisopropyl-4,4′-diaminodiphenylmethane and mixtures thereof.

5. A coating composition obtainable by reacting components (i) and (ii) of the two-component coating system according to claim 1 in a proportion corresponding to an NCO/NH₂ equivalents ratio of from 0.5:1 to 1.5:1.

6. A coating composition according to claim 5, comprising one or more additives selected from the group consisting of pigments, fillers, plasticizers such as coal tar, and leveling assistants.

7. A process for producing elastic coatings comprising:
mixing the components of the two-component coating system according to claim 1 in a proportion corresponding to an NCO/NH₂ equivalents ratio of from 0.5:1 to 1.5:1;
applying the mixture to a substrate; and
curing the two-component coating system mixture.

8. A polyurea polymer prepared by reacting the coating composition according to claim 2.
